(19) United States
(12) Patent Application Publication
(10) Pub. No.: US 2022/0394029 A1
(43) Pub. Date: Dec. 8, 2022

(54) Technique for communication between an application implementing a service and a server

(71) Applicant: Orange, Issy-Les-Moulineaux (FR)

(72) Inventors: Gilles Le Brun, Chatillon Cedex (FR); Sébastien Brault, Chatillon Cedex (FR); Julien Galhaut, Chatillon Cedex (FR); Eric Malville, Chatillon Cedex (FR)

(21) Appl. No.: 17/770,171

(22) PCT Filed: Oct. 13, 2020
(86) PCT No.: PCT/FR2020/051804

§ 371 Date: Apr. 19, 2022

(30) Foreign Application Priority Data
Oct. 21, 2019 (FR) FR1911757

(51) Int. Cl. H04L 9/40

(52) U.S. Cl. CPC H04L 63/0823

(57) ABSTRACT

A method for communication between an application implementing a service run on a user device and a main server. When an attempt is made to establish a first secure communication, the compliance of a public key certificate sent by the main server is checked against a reference certificate for the main server, the establishment of secure communication being conditional upon the compliance check. If the public key certificate sent by the main server is not compliant, a second secure communication is established with an update server, and a public key certificate sent by the update server is checked for compliance against a reference certificate for the update server. Once the second secure communication has been established, an updated reference certificate for the main server is received, the updated certificate being intended to be used by the client application the next time secure communication is established with the main server.

### CROSS-REFERENCE TO RELATED APPLICATIONS

This Application is a Section 371 National Stage Application of International Application No. PCT/FR2020/051804, filed Oct. 13, 2020, which is incorporated by reference in its entirety and published as WO 2021/079041 A1 on Apr. 29, 2021, not in English.

### FIELD OF THE DISCLOSURE

The invention relates to the general field of telecommunications.

The invention more particularly relates to a technique of communication between a user device, and more precisely an application implementing a service, and a server. It is particularly advantageously applicable in the context of the verification of compliance carried out by the application to set up a secure communication with the server.

### BACKGROUND OF THE DISCLOSURE

The TLS protocol (TLS being the acronym of Transport Layer Security) is a protocol for securing exchanges on a wide-area communication network, such as the Internet. This TLS protocol makes it possible to set up a secure exchange (or secure communication) between an application implementing a service, also called a client application, and a server. In order to authenticate the server, the client application verifies the compliance of an X509 public key certificate transmitted by the server, by comparing it to a reference certificate associated with the server. To this end, the client application is configured to store this reference certificate. This verification of certificate compliance is known as “certificate pinning” This software technique makes it possible to authenticate the server and avoid man-in-the-middle attacks.

However, the reference certificate associated with the server must be renewed regularly (for example every year) for security reasons. Given that the reference certificate is stored during the configuration of the client application, to update this reference certificate it is necessary to update all of the client applications, so that they all have the updated reference certificate. This is complex to implement, in particular in terms of organization and synchronized deployment of the updated reference certificate to all client applications.

### SUMMARY

One of the aims of the invention is to remedy shortcomings/drawbacks of the prior art and/or to make improvements thereto.

According to a first aspect, the subject of the invention is a method of communication between an application implementing a service being executed on a user device and a main server. This method comprises, in the client application:
a verification of compliance of a public key certificate transmitted by the main server during an attempt to set up a first secure communication, as a function of a reference certificate for said main server, a setup of secure communication being conditional upon said verification of compliance;
when said public key certificate transmitted by the main server is not verified compliant, a setup of a second secure communication with an update server with verification of compliance of a public key certificate transmitted by the update server, as a function of a reference certificate for said update server;
a receipt of an updated reference certificate for said main server by means of the second secure communication, said updated certificate being intended to be used by the client application during a new setup of secure communication with the main server.

The proposed technique thus makes it possible to update the reference public key certificate used for a verification of compliance of a server, called the main server, by an application implementing a service, during the setup of a secure communication. This update is carried out in a way that is transparent to the user of the application. It is not necessary to download the application again in order to update the reference certificate. Specifically, the proposed technique makes it possible to receive the reference certificate for the main server by means of a secure communication set up with an update server. In addition, the reference certificate for the main server may be deployed asynchronously to the various user devices executing the application. Each of these user devices is updated during the first attempt to set up secure communication after the expiration of the validity of the reference certificate for the main server or indeed after a renewal of the public key certificate of the main server, for example as a result of a corruption of this certificate. It is underlined here that the term “reference certificate” is used here to designate the public key certificate for the main server that will be used to implement the verification of compliance in the client application. Of course, only the main server is the reference as regards the up-to-date public key certificate.

The reference certificate for the update server is dedicated to the update of the reference certificate for the main server.

The proposed technique thus makes it possible to rapidly update the reference certificate to be used to implement a verification of compliance for the main server, when the public key certificate of the main server has expired or even when this certificate has had to be renewed.

The various embodiments or features mentioned below may be added independently or in combination with one another to the communication method such as defined above.

In one particular embodiment, the communication method comprises, when a third secure communication is set up with the main server, a receipt of an updated reference certificate for said update server by means of the third secure communication.

Thus, the secure communication set up between the main server and the application implementing the service is relied on to update the reference certificate for the update server. This makes it possible to guarantee that the reference certificate for the update server will itself be up to date when the reference certificate for the server needs to be modified. The reference certificate for the update server may be updated rapidly, in order to allow a verification of compliance for the update server, when the public key certificate of the update server has expired or indeed when this certificate has had to be renewed.

In one particular embodiment, the expiration date of the reference certificate for the update server is later than that of the reference certificate for the main server.

This makes it possible to guarantee that the reference certificate for the update server will be valid during the update of the reference certificate for the main server.

In one particular embodiment, the communication method comprises, when the received reference certificate for the main server is identical to the reference certificate used during the verification of compliance, a modification of an access network underlying the communication network with a view to attempting a new setup of a secure communication with the main server.

In one particular embodiment, the communication method comprises, when the second secure communication cannot be set up with the update server, a modification of an access network underlying the communication network with a view to attempting a new setup of a secure communication with the main server.

These two embodiments make it possible to avoid errors related to a malfunction of the access network underlying the communication network.

According to a second aspect, the invention relates to a user device comprising:
a module for verification of compliance, which module is arranged to verify the compliance of a public key certificate transmitted by a server during an attempt to set up a secure communication, as a function of a reference certificate for said server, a setup of secure communication being conditional upon said verification of compliance;
an application module implementing a service being executed on the user device and a main server, arranged to:
   order a setup of a first secure communication with a main server with verification of compliance of a public key certificate transmitted by the main server, as a function of a reference certificate for said main server,
   order a setup of a second secure communication with an update server with verification of compliance of a public key certificate transmitted by the update server, as a function of a reference certificate for said update server, when said public key certificate transmitted by the main server is not verified compliant, and
   receive an updated reference certificate for said main server by means of the second secure communication, said updated certificate being intended to be used by the client application during a new setup of secure communication with the main server.

The stated advantages of the communication method according to the first aspect are directly transposable to a user device.

This user device may of course include, in structural terms, the various features relating to the communication method as described above, which features may be combined or taken individually.

According to a third aspect, the invention relates to a system. This system comprises a user device according to the second aspect and a main server arranged to implement a service with the user device, said system further comprising an update server, arranged to send an updated reference certificate for the main server by means of a secure communication set up with verification of compliance, said updated certificate being intended to be used by the client application during a new setup of secure communication with the main server.

This system may of course include, in structural terms, the various features relating to the communication method as described above, which features may be combined or taken individually.

According to a fourth aspect, the invention relates to a program for a user device, comprising program code instructions that are intended to order the execution of the steps of the communication method described above, which steps are implemented by a user device when this program is executed by this device, and to a storage medium readable by a device on which a program for a user device is stored.

The stated advantages of the communication method according to the first aspect are directly transposable to the program for a user device and to the storage medium.

### BRIEF DESCRIPTION OF THE DRAWINGS

The technique of communication between an application implementing a service being executed on a user device and a main server will be better understood on reading the following description of particular embodiments, with reference to the appended drawings, in which:

FIG. 1 shows a system in which is implemented the communication method in one particular embodiment;

FIG. 2 illustrates steps of a communication method according to one particular embodiment;

FIG. 3 shows a user device in one particular embodiment.

### DETAILED DESCRIPTION OF ILLUSTRATIVE EMBODIMENTS

FIG. 1 shows a system 2 in which is implemented the communication method in one particular embodiment. This system 2 comprises:
a user device 10, on which is being executed a client application implementing a service;
a server 20, also called the main server, on which is being executed an application implementing the service;
an update server 21, able to provide to a client application a reference certificate for the main server 20.

The user device 10 is for example a mobile device, a tablet, a connected object, a hardware security element such as a SIM card (SIM being the acronym of Subscriber Identity Module), an eUICC (eUICC being the acronym of embedded Universal Integrated Circuit Card)—also called an eSIM (eSIM being the acronym of embedded Subscriber Identity Module) or non-removable SIM card—an eSE (eSE being the acronym of embedded Secure Element), a software security element—for example an emulated card hosted on a server located in the network of an operator—, etc.

The user device 10 communicates with the main server 20 and update server 21 via a communication network 1, for example a wide-area communication network such as the Internet. This communication network 1 is based on an underlying access network (not shown in FIG. 1) such as a mobile access network.

An X.509 public key certificate C_PPc has been obtained by the main server 20 from a certification authority (not shown in FIG. 1).

A public key certificate such as defined by the X.509 standard in particular comprises:
information on the public key: a public key algorithm and the public key corresponding to a secret key that the holder of the certificate knows;
information on the validity of the certificate (start date, expiration date);
a signature of the certificate, which signature is provided by a certification authority.

Below, the TLS protocol (TLS being the acronym of Transport Layer Security) is used to set up a secure exchange (or secure communication) between an application implementing a service, also called the client application, and a server. In order to authenticate the server, the client application verifies the compliance of an X509 certificate transmitted by the server, by comparing it to a reference certificate associated with the server. To this end, the client application is configured to store this reference certificate. This verification of certificate compliance is known as “certificate pinning”.

Below, the embodiment described is one in which, to set up a secure communication with the main server 20, the client application performs a verification of compliance of the public key certificate C_PPc transmitted by this main server 20. To this end, the client application and a reference certificate C_PPr for the main server 20 are stored in a memory region of the user device 10. To perform the verification of compliance, the client application compares the public key certificate C_PPc transmitted by the main server 20 with the reference certificate C_PPr stored for the same main server 20. When the result of the comparison is negative, the setup of the secure communication between the client application and the main server is stopped. The client application cannot be executed in collaboration with the application implementing the service being executed on the main server 20. This negative result may be due to an update of the public key certificate of the main server, which update is for example related to an expiration of this certificate or even to a renewal of the public key certificate of the main server, as a result for example of a corruption of this certificate. There is no limitation on the reasons leading to the update of the certificate. When the result of the comparison is positive, the public key certificate C_PPc transmitted by the main server 20 being verified compliant with the reference certificate C_PPr stored for the same main server 20, the secure communication between the client application and the corresponding application on the main server is set up and the client application may execute the service in collaboration with the main server 20. A setup of secure communication between the client application and the main server 20 is conditional upon the verification of compliance.

An X.509 public key certificate C_UPDc has been obtained by the update server 21 from a certification authority (not shown in FIG. 1).

In the described embodiment, the reference certificate C_UPDc for the update server 21 (called C_UPDr below) is also stored, with the client application and the reference certificate C_PPr for the main server 20, in a memory region of the user device 10. This reference certificate C_UPDr is intended to be used to verify the compliance of the update server 21 during the setup of a secure communication between the client application and the update server 21. As described above with reference to the main server 20, a setup of secure communication between the client application and the update server 21 is conditional upon the verification of compliance.

In one particular embodiment, the expiration date of the reference certificate C_UPDr for the update server 21 is later than that of the reference certificate C_PPr for the main server 20.

The update server 21 also stores the public key certificate C_PPc for the main server 20 in a memory region. This public key certificate C_PPc is intended to be transmitted by the update server 21 to the client application, once a secure communication has been set up with a verification of compliance between the client application and the update server 21. When the public key certificate C_PPc is updated, for example because of an expiration or even a renewal, it is stored on the two servers, the main server 20 and the update server 21, so that the update server 21 is always able to transmit the up-to-date public key certificate C_PPc (the latter then becoming C_PPr for the client application).

In one particular embodiment, the main server 20 is also able to provide the client application with a reference certificate for the update server 21. This public key certificate C_UPDc for the update server 21 is intended to be transmitted by the main server 20 to the client application, once a secure communication has been set up with verification of compliance between the client application and the main server 20.

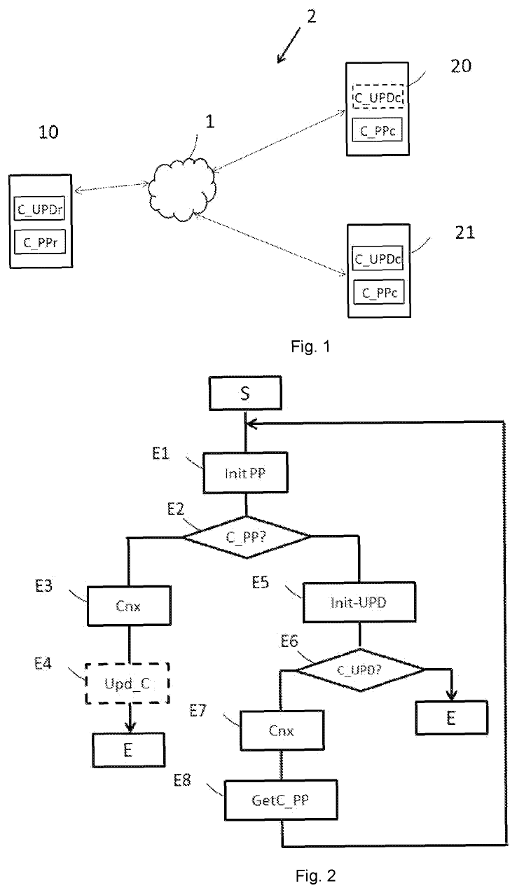

The method of communication between an application implementing a service being executed on a user device 10 and a main server 20, and more precisely the application being executed on the main server, will now be described with reference to FIG. 2 in a system 2 such as shown in FIG. 1.

In a step E1, the application implementing the service being executed on the user device 10, which application is called the client application below, initializes the setup of a secure communication with the main server 20 by means of the TLS protocol. This step E1 is not described in more detail, as it is known to those skilled in the art. During this step E1 of attempting to set up a secure communication, the main server 20 transmits to the client application a public key certificate C_PPc.

In a step E2, a verification of compliance of the public key certificate C_PPc transmitted by the main server is carried out by comparing it with a reference certificate C_PPr for this main server 20, which is stored with the client application. A setup of secure communication is conditional upon the verification of compliance.

When the public key certificate C_PPc transmitted by the main server is verified compliant in step E2, in a step E3, the secure communication is set up and the service may be executed.

When the public key certificate C_PPc transmitted by the main server is not verified compliant in step E2, the client application initiates a setup of a second secure communication with the update server 21 in a step E5. To set up this second secure communication, in a step E6, a verification of compliance of a public key certificate C_UPDc transmitted by the update server 21 is carried out by the client application by comparing this certificate with a reference certificate C_UPDr for this update server.

When the public key certificate C_UPDc transmitted by the update server is verified compliant in step E6, in a step E7, the secure communication is set up.

In a step E8, the client application receives an updated public key certificate C_PPc for the main server 20 by means of the secure communication that has been set up. This updated public key certificate is stored as reference certificate C_PPr for the main server 20 in the memory region. The reference certificate is intended to be used by the client application during a new setup of secure communication with the main server. The method then again implements step E1 with a view to setting up a secure communication between the client application and the main server 20. If the client application successfully sets up a secure communication with the main server with a verification of compliance using the new reference certificate, then the update of the reference main certificate is confirmed for the client application. Thus it is possible to update the public key certificate of the main server in a decentralized and asynchronous manner This makes it possible to react more rapidly to situations in which the public key certificate of the main server must be modified.

When the public key certificate C_UPDc transmitted by the update server is not verified compliant in step E6, the method ends. The client application must then be updated as a function of the public key certificate associated with the main server, for example via download of a new version of the client application.

In one particular embodiment, in a step E4, the public key certificate C_UPDc of the update server is sent by the main server by means of the secure communication set up, for example following step E3 described above. This certificate is then stored in a memory region as reference certificate C_UPDr for the update server 21. This makes it possible to guarantee that the reference certificate C_PPr for the main server 20 will be able to be updated as described above, since the secure communication with the update server will be able to be set up.

The public key certificate C_UPDc of the update server may be sent at regular time intervals or when necessary. It may also be sent on the request by the client application or indeed in an unsolicited manner

In one particular embodiment, this update of the public key certificate C_UPDc of the update server is anticipated by indicating a start date for the certificate later than the send date. This makes it possible to anticipate the update of the public key certificate for the update server 21.

It is recalled here that, to implement the method, during the update of the public key certificate for the update server in step E4, the expiration date of the public key certificate for the update server must be later than the expiration date of the public key certificate for the main server.

In one particular embodiment, when the public key certificate C_UPDc transmitted by the update server is not verified compliant in step E6, a counter is incremented on each new failed attempt. This counter is reset to zero when the update of the reference main certificate is confirmed for the client application. A wait is also triggered on the first occurrence of a non-compliance of the public key certificate for the update server. When the counter exceeds a threshold value or the wait expires without the public key certificate for the main server having been able to be updated, the method ends. The client application must then be updated as a function of the public key certificate associated with the main server, for example via download of a new version of the client application. Thus, aborted attempts to update the public key certificate for the main server in the client application are limited in number and in time.

In one particular embodiment, in step E8 of receiving an updated public key certificate for the main server by means of the secure communication, the client application checks whether the received public key certificate C_PPc is unchanged. In this case, the update has failed and the method ends.

In one particular embodiment, if the update server cannot be reached, it is not possible to perform the update and the method ends.

Various cases in which it is not possible to update the reference certificate for the main server have been described above: for example, when the received reference certificate for the main server is identical to the reference certificate used for the failed verification of compliance, or indeed when the second secure communication cannot be set up with the update server. For these various cases, instead of returning to a complete download of the application as described above, in one particular embodiment, the client application orders a modification of an access network underlying the communication network with a view to attempting a new setup of a secure communication with the main server. The reference certificate for the main server remains unchanged. This modification order may be triggered by the user following a request made to the user by means of the human-machine interface, asking him to connect by means of another access network.

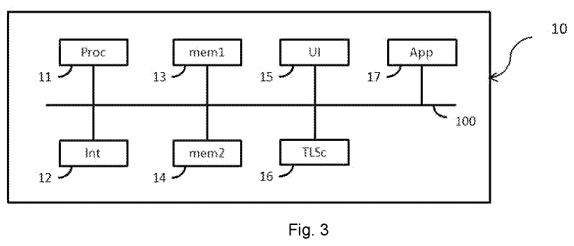

FIG. 3 schematically illustrates a user device 10 in one particular embodiment. The user device 10 in particular comprises:
a hardware processor 11 for executing code instructions of software modules;
a memory region 13, configured to store a program that comprises code instructions for implementing steps of the method of communication between an application implementing a service and a server;
a storage memory 14, configured to store data used during the implementation of the method of communication between an application implementing a service and a server, i.e. data such as parameters used for computations performed by the processor 11, intermediate data of computations carried out by the processor 11, etc.;
a network interface 12;
a human-machine interface 15;
a module 16 for verification of compliance, which module is arranged to verify the compliance of a public key certificate transmitted by a server during an attempt to set up a secure communication, as a function of a reference certificate for said server, a setup of secure communication being conditional upon said verification of compliance;
an application module 17 implementing a service being executed on the user device and a main server 20;
   which are connected to each other through a bus 100.

Of course, the constituent elements of the user device may be connected by means of a connection other than a bus.

The processor 11 orders the operations of the user device. The memory region 13 stores at least one computer program code that, when it is executed by the processor 11, implements the various functions of the application module. The processor 11 may be formed by any known and suitable hardware or software, or by a combination of hardware and software. For example, the processor 11 may be formed by dedicated hardware, such as a processing circuit, or by a programmable processing unit such as a central processing unit which executes a program stored in a memory thereof.

The memory region 13 may be formed by any suitable means capable of storing the program in a computer-readable manner Examples of the memory region 13 comprise computer-readable non-transitory storage media such as: semiconductor memory devices; and magnetic, optical, or magneto-optical storage media loaded into a read-write unit. The program causes the processor 11 to execute a method of communication between an application implementing a service and a server according to one particular embodiment.

A network interface 12 provides a connection between the user device 10 and a server via a communication network based on an underlying access network. The network interface 12 may provide, as a function of its nature, a wired or wireless connection.

The application module 17 is further arranged to:
order the module 16 for verification of compliance to set up a first secure communication with a main server with verification of compliance of a public key certificate transmitted by the main server, as a function of a reference certificate for said main server,
order the module 16 for verification of compliance to set up a second secure communication with an update server with verification of compliance of a public key certificate transmitted by the update server, as a function of a reference certificate for said update server, when said public key certificate transmitted by the main server is not verified compliant, and
receive an updated reference certificate for said main server by means of the second secure communication, said updated certificate being intended to be used by the client application during a new setup of secure communication with the main server.

In one particular embodiment, the application module 17 is further arranged to receive an updated reference certificate for the update server 21 by means of a secure communication set up with the main server.

In one particular embodiment, the application module 17 is further arranged to order a modification of an access network underlying the communication network with a view to attempting a new setup of a secure communication with the main server, when the received reference certificate for the main server is identical to the reference certificate used during the verification of compliance.

In one particular embodiment, the application module 17 is further arranged to order a modification of an access network underlying the communication network with a view to attempting a new setup of a secure communication with the main server, when the second secure communication cannot be set up with the update server.

In these two embodiments, the application module 17 may further be arranged to ask the user to connect by means of another access network by means of the human-machine interface 15.

It is underlined here that the user device 10 also comprises other processing modules (not shown in FIG. 3) configured to implement the various functions of this device.

In addition, the main server 20 in particular comprises:
a hardware processor for executing code instructions of software modules;
a memory region, configured to store a program that comprises code instructions for implementing steps of the method of communication between an application implementing a service on a user device and the main server;
a storage memory, configured to store data used during the implementation of the method of communication between an application implementing a service and the main server, i.e. data such as parameters used for computations performed by the processor, intermediate data of computations carried out by the processor, etc.;
a network interface;
a module for setting up a secure communication with verification of compliance, which module is arranged to transmit to a user device a public key certificate during an attempt to set up a secure communication, a setup of secure communication being conditional upon said verification of compliance;
an application module implementing a service being executed on the main server 20 and the user device;
   which are connected to each other through a bus.

In one particular embodiment, the application module of the main server is further arranged to transmit a reference certificate for the update server 21, once a secure communication has been set up with a verification of compliance.

It is underlined here that the main server 20 also comprises other processing modules, configured to implement the various functions of this server.

The update server 21 in particular comprises:
a hardware processor for executing code instructions of software modules;
a memory region, configured to store a program that comprises code instructions for implementing steps of the method of communication between an application implementing a service on a user device and the update server;
a storage memory, configured to store data used during the implementation of the method of communication between an application implementing a service and the update server, i.e. data such as parameters used for computations performed by the processor, intermediate data of computations carried out by the processor, etc.;
a network interface;
a module for setting up a secure communication with verification of compliance, which module is arranged to transmit to a user device a public key certificate during an attempt to set up a secure communication, a setup of secure communication being conditional upon said verification of compliance;
an application module implementing a service being executed on the update server 21 and the user device, arranged to transmit an updated reference certificate for the main server;
   which are connected to each other through a bus.

It is underlined here that the update server also comprises other processing modules, configured to implement the various functions of this server.

The communication technique between an application implementing a service and a server is implemented by means of software and/or hardware components. In this regard, the term “module” may correspond in this document equally to a software component, to a hardware component or to a set of hardware and/or software components, able to implement a function or a set of functions, according to what is described above in respect of the module in question.

A software component corresponds to one or more computer programs, one or more subroutines of a program, or more generally to any element of a program or of software. Such a software component is stored in memory and then loaded and executed by a data processor of a physical entity, and is able to access the hardware resources of this physical entity (memories, recording media, communication buses, electronic input/output cards, user interfaces, etc.).

In the same way, a hardware component corresponds to any element of a hardware assembly. It may be a programmable or non-programmable hardware component, with or without an integrated processor for executing software. It is for example an integrated circuit, a chip card, an electronic card for the execution of firmware, etc.

In one particular embodiment, the user device 10 is configured to implement steps of the method of communication between an application implementing a service and a server described above, said steps being implemented by a user device. These are preferably software modules comprising software instructions for getting the steps (or the actions) of the communication method described above, which steps are implemented by a user device, executed. The invention therefore also relates to:
a program for a user device, comprising program code instructions intended to order the execution of the steps (or the actions) of the communication method described above, when said program is executed by this device;
a storage medium readable by a user device and on which is stored the program for a device.

The software modules may be stored in or transmitted by a data medium. This may be a hardware storage medium, for example a CD-ROM, a floppy disk or a hard disk, or else a transmission medium such as an electrical, optical or radio signal, or a telecommunication network.

The invention therefore also relates to a user device configured to set up a communication between an application implementing a service being executed on a user device 10 and a main server 20, this user device comprising a processor configured to:
verify compliance of a public key certificate transmitted by the main server during an attempt to set up a first secure communication, as a function of a reference certificate for said main server, a setup of secure communication being conditional upon said verification of compliance;
set up a second secure communication with an update server 21 with verification of compliance of a public key certificate transmitted by the update server, as a function of a reference certificate for said update server, when said public key certificate transmitted by the main server is not verified compliant;
receive an updated reference certificate for said main server by means of the second secure communication, said updated certificate being intended to be used by the client application during a new setup of secure communication with the main server.

The invention also relates to a system 2 comprising a user device 10 such as described above, a main server 20 arranged to implement a service with the user device, and an update server 21, arranged to send an updated reference certificate for the main server by means of a secure communication set up with verification of compliance, said updated certificate being intended to be used by the client application during a new setup of secure communication with the main server.

The invention also relates to a main server configured to set up a communication between an application implementing a service being executed on a user device 10 and this main server, this main server comprising a processor configured to transmit a public key certificate to a user device for a verification of compliance during an attempt to set up a secure communication, a setup of secure communication being dependent on said verification of compliance.

In one particular embodiment, the processor of the main server 20 is further configured to send an updated reference certificate for the update server 21 by means of a secure communication set up with verification of compliance.

The invention therefore also relates to an update server configured to set up a communication between an application implementing a service being executed on a user device 10 and this update server, this update server comprising a processor configured to:
transmit a public key certificate to a user device for a verification of compliance during an attempt to set up a secure communication, a setup of secure communication being dependent on said verification of compliance;
transmit an updated reference certificate for the main server by means of the secure communication, this updated certificate being intended to be used by the client application during a new setup of secure communication with the main server.

Although the present disclosure has been described with reference to one or more examples, workers skilled in the art will recognize that changes may be made in form and detail without departing from the scope of the disclosure and/or the appended claims.

1. A method of communication between a client application implementing a service being executed on a user device and a main server, said method comprising, in the client application:
verifying compliance of a public key certificate transmitted by the main server during an attempt to set up a first secure communication, as a function of a reference certificate for said main server, a setup of secure communication being conditional upon said verification of compliance;
in response to said public key certificate transmitted by the main server being not verified compliant, setting up a second secure communication with an update server and verifying compliance of a public key certificate transmitted by the update server, as a function of a reference certificate for said update server; and
receiving an updated reference certificate for said main server by using the second secure communication, said updated certificate being intended to be used by the client application during a new setup of secure communication with the main server.

2. The method as claimed in claim 1, comprising, after a third secure communication is set up with the main server, receiving an updated reference certificate for said update server by using the third secure communication.

3. The method as claimed in claim 1, wherein an expiration date of the reference certificate for the update server is later than that of the reference certificate for the main server.

4. The method as claimed in claim 1, comprising, in response to the received reference certificate for the main server being identical to the reference certificate used during the verification of compliance, modifying an access network underlying the communication network with a view to attempting a new setup of a secure communication with the main server.

5. The method as claimed in claim 1, comprising, in response to the second secure communication not being able to be set up with the update server, a modifying an access network underlying the communication network with a view to attempting a new setup of a secure communication with the main server.

6. A user device comprising:
a verification module, which is arranged to verify compliance of a public key certificate transmitted by a server during an attempt to set up a secure communication, as a function of a reference certificate for said server, and set up a secure communication conditional upon said verification of compliance;
an application module implementing a service being executed on the user device and a main server, arranged to:
order a setup of a first secure communication with a main server with verification of compliance of a public key certificate transmitted by the main server, as a function of a reference certificate for said main server,
order a setup of a second secure communication with an update server with verification of compliance of a public key certificate transmitted by the update server, as a function of a reference certificate for said update server, when said public key certificate transmitted by the main server is not verified compliant, and
receive an updated reference certificate for said main server by using the second secure communication, said updated certificate being intended to be used by the client application during a new setup of secure communication with the main server.

7. A system comprising the user device as claimed in claim 6, the main server and the update server.

8. (canceled)

9. A non-transitory computer-readable storage medium comprising program code instructions which when executed by a processor of a user device configure the user device to implement a communication method between a client application implementing a service being executed on the user device and a main server, said method comprising, in the client application:
verifying compliance of a public key certificate transmitted by the main server during an attempt to set up a first secure communication, as a function of a reference certificate for said main server, a setup of secure communication being conditional upon said verification of compliance;
in response to said public key certificate transmitted by the main server being not verified compliant, setting up a second secure communication with an update server and verifying compliance of a public key certificate transmitted by the update server, as a function of a reference certificate for said update server; and
receiving an updated reference certificate for said main server by using the second secure communication, said updated certificate being intended to be used by the client application during a new setup of secure communication with the main server.
